(19) United States
(12) Patent Application Publication
(10) Pub. No.: US 2026/0062955 A1
(43) Pub. Date: Mar. 5, 2026

(54) STRAND LOCK

(71) Applicant: ABUS August Bremicker Söhne KG, Wetter-Volmarstein (DE)

(72) Inventor: Ernst Pankratius, Wetter (DE)

(21) Appl. No.: 19/309,785

(22) Filed: Aug. 26, 2025

(30) Foreign Application Priority Data
Aug. 27, 2024 (DE) 10 2024 124 462.3

(51) Int. Cl. E05B 37/00; E05B 37/02; E05B 71/00

(52) U.S. Cl. CPC E05B 37/0058; E05B 37/02; E05B 71/00

(57) ABSTRACT

A strand lock includes: a lock body having a first closure part and a second closure part; a combination locking mechanism oriented along a lock axis; and a strand hoop. A first strand end is formed by a bolt that can be selectively locked to or released from the lock body. The first closure part has a bolt introduction opening into which the bolt can be introduced. The combination locking mechanism includes rotatable code rings and a preloaded latch. When a secret code is set, the latch is released for movement against the preload into an unlocking position, where the latch unblocks a movement path of the bolt for an introduction or removal from the lock body. When the secret code is set, he latch may be urged into the unlocking position by introducing the bolt into the lock body and by removing the bolt from the lock body.

### FIELD

The present disclosure relates to a strand lock including a lock body, which has a first closure part, a second closure part, and a combination locking mechanism oriented along a lock axis, and a strand hoop extending from a first strand end to a second strand end, wherein the first strand end is formed by a bolt that may be selectively locked to the lock body or released from the lock body, and wherein the second strand end is permanently fastened to the second closure part.

### BACKGROUND

Such a strand lock may in particular make it possible to form a closed loop by locking the bolt and thus the first strand end to the lock body in order, as a result, to securely connect two objects to one another. Therefore, such a strand lock may, for instance, be used as a bicycle lock to connect a frame section of the bicycle to a stationary object and, for example, to a bicycle stand through the closed loop so that the bicycle may be secured to the bicycle stand after locking the bolt. Alternatively thereto, provision may, for example, be made to guide the strand hoop between two spokes of a wheel and around a frame section of the bicycle such that the loop formed by the strand lock blocks a rotation of the wheel and the bicycle is thereby secured against an unauthorized riding away. A strand hoop may, for example, be a rope hoop or a chain hoop.

Conventionally, with such strand locks comprising a combination locking mechanism, provision is made that the bolt that is selectively introducible into the lock body is introduced along the lock axis into the lock body and is locked there by way of the combination locking mechanism. However, this requires an undesirably complex design of the bolt since the bolt must have the structures required for cooperating with the combination locking mechanism to be able to enable a reliable locking. In this regard, the bolt in conventional strand locks so-to-say itself acts as a latch of the combination locking mechanism that may be selectively blocked against a movement relative to the lock body. Furthermore, structures formed at the bolt may be increasingly exposed to external influences or other stresses when the bolt is removed from the lock body, which may possibly be accompanied by damage to or wear of the structures provided at the bolt. This may possibly also affect the reliability of the locking.

### SUMMARY

It is therefore an object of the present disclosure to provide a strand lock that enables a reliable locking with a simplified design of the bolt and a convenient handling.

This object is satisfied by a strand lock according to the present disclosure.

In the case of this strand lock, the first closure part has a bolt introduction opening through which the bolt may be introduced into the lock body along an introduction direction oriented transversely, in particular perpendicular, to the lock axis. The combination locking mechanism has a plurality of code rings rotatable about the lock axis for setting a numerical code and a latch preloaded along the lock axis, in particular towards the first closure part, into a locking position, wherein the bolt has a locking notch into which the latch engages in the locking position when the bolt is introduced into the lock body. The latch is further released for a movement against the preload into an unlocking position when a numerical code is set at the code rings that corresponds to a secret code, wherein, in the unlocking position, the latch unblocks a movement path of the bolt for an introduction into the lock body or for a removal from the lock body. On the other hand, the latch is blocked against a movement into the unlocking position if a numerical code is set at the code rings that does not correspond to the secret code. Furthermore, when the secret code is set, the latch may be urged from the locking position into the unlocking position by introducing the bolt that is released from the lock body into the lock body and by removing the bolt that is introduced into the lock body.

Since the first closure part has a bolt introduction opening through which the bolt may be introduced into the lock body transversely and in particular perpendicular to the lock axis, the bolt-unlike with conventional strand locks-no longer has to be introduced along the lock axis. This makes it possible to arrange a latch in the lock body, which latch may be moved along the lock axis and thus in particular along a maximum extent of the lock body between a locking position and an unlocking position, and to use said latch to selectively block a movement of the bolt for a removal from the lock body, said movement oriented transversely and in particular perpendicular to the lock axis, or to release the bolt for this movement. As is known from other types of hoop locks, the bolt may therefore be configured in a simple manner with a locking notch into which the latch may engage in the locking position in order, as a result, to reliably secure the bolt against a removal from the lock body. On the other hand, the bolt does not need to have any other locking structures to be able to cooperate with components of the combination locking mechanism and, for example, the code rings (or coupling rings coupled thereto) as a latch that may be selectively introduced into the lock body.

The bolt introduced into the lock body may thus be reliably secured against a release from the lock body by the latch, which is in the locking position and is blocked in the locking position, since the latch, by engaging into the locking notch of the bolt, blocks the bolt against a movement out of the lock body. By moving the latch into the unlocking position, on the other hand, a movement path described by the bolt may be released for an introduction into the lock body or for a removal from the lock body so that the bolt introduced into the lock body may in particular be released for a detachment from the lock body by moving the latch into the unlocking position.

To further enable a convenient handling of the strand lock, the latch may, when the secret code is set, be moved by the bolt from the locking position against the preload into the unlocking position so that, when the secret code is set, the bolt may so-to-say urge the latch out of its own movement path into the unlocking position to be able to be introduced into the lock body or removed from the lock body. Due to this cooperation of the bolt with the latch, it is thus not necessary to provide an additional actuation element and, for example, a slider or a knob that is accessible at the outer side of the lock body in order to move the latch against the preload into the unlocking position. Rather, only the secret code has to be set, whereupon the bolt may immediately be moved relative to the lock body to be able to be introduced into the lock body or removed from the lock body.

Furthermore, the preload of the latch into the locking position may, however, make it possible for the latch to immediately move back into the locking position and engage into the locking notch when the bolt is fully introduced into the lock body and the locking notch is arranged in alignment with the latch with respect to the lock axis. The preload of the latch may further in particular be selected such that the weight of the bolt and/or the strand hoop is not sufficient to urge the latch against the preload into the unlocking position so that the latch may hold the bolt fully introduced into the lock body against an unintentional release from the lock body even when the secret code is set. By subsequently adjusting the numerical code, the bolt may then be locked to the lock body and may be secured against being deliberately pulled out of the lock body.

The locking notch may in particular be designed as revolving around the bolt so that the bolt may be introducible into the bolt introduction opening in any desired rotational position with respect to the introduction direction and may be lockable to the lock body. Alternatively thereto, it may, however, generally also be provided that the locking notch is designed as a merely local recess at the bolt and that the bolt must be introduced into the lock body in a predetermined rotational position to enable a locking of the bolt.

In general, the strand lock may, for example, be configured as a rope lock or a chain lock. The strand hoop of a rope lock may in particular be formed by a wire rope, while the strand hoop of a chain lock may be configured as a chain comprising a plurality of chain links.

Furthermore, the strand hoop of the strand lock may in particular be flexible and may be transferrable into an orientation in which the strand hoop extends from the first strand end to the second strand end along a straight connecting line. In this respect, the first strand end may be rotatable relative to the second strand end and the lock body about such a connecting line.

Further embodiments are explained throughout the disclosure, in the description, and with reference to the drawings.

In some embodiments, the bolt and the latch may have chamfers that cooperate during the introduction and/or the removal of the bolt, wherein the latch may be able to be urged into the unlocking position by the cooperation of the chamfers. The cooperating chamfers may in particular be curved, wherein a planar design of the chamfers may, however, generally also be provided.

Since the bolt and the latch may have cooperating chamfers, a force exerted by the bolt on an introduction along the introduction direction or on a removal against the introduction direction may be deflected in order, as a result, to be able to urge the latch against the preload into the unlocking position transversely and in particular perpendicular to the introduction direction. Such chamfers may, for example, be designed as planar surfaces oriented obliquely to the introduction direction and to the lock axis, wherein, alternatively thereto, non-planar curved chamfers may also be provided. The force to be applied to urge back the latch may possibly be higher in the case of curved chamfers compared to planar chamfers, wherein, conversely, a more reliable holding of the bolt in the lock body against an unintentional release when the secret code is set may be achieved, however.

In general, the chamfers may be formed such that the (possibly curved) surfaces of both the bolt and the latch forming the chamfers move increasingly away from the lock axis along the lock axis, viewed in the direction of the unlocking position.

In some embodiments, the latch may have an engagement section that, in the locking position, engages into the locking notch of the bolt. Furthermore, the latch may, with respect to the introduction direction, have a first chamfer at an upper side (facing the bolt introduction opening) and a second chamfer at a lower side opposite the upper side, wherein, in the locking position, the second chamfer faces a removal chamfer of the locking notch of the bolt, and wherein the latch may be urged back against the preload by a cooperation of the removal chamfer with the second chamfer on a removal of the bolt from the lock body. Furthermore, the bolt may have an introduction chamfer at a bolt end that may be introduced into the lock body and the latch may be able to be urged back against the preload by a cooperation of the introduction chamfer with the first chamfer on an introduction of the bolt into the lock body.

In particular, in such embodiments, the locking notch may furthermore be bounded by the removal chamfer and a reception chamfer opposite the removal chamfer, wherein the removal chamfer may extend parallel to the second chamfer and the reception chamfer may extend parallel to the first chamfer when the bolt is introduced into the lock body and the latch is in the locking position.

In such embodiments, the latch preloaded into the locking position may thus be contacted by the introduction chamfer formed at the bolt end during an introduction of the bolt into the lock body, wherein a deflection of the force exerted by the bolt along the introduction direction onto the latch may be achieved by the cooperation of the introduction chamfer with the first chamfer. As soon as the bolt is fully introduced into the lock body and the locking notch is in alignment with the latch, viewed along the lock axis, the latch may snap back into the locking position and may engage into the locking notch, wherein the second chamfer may in this respect face the removal chamfer as a boundary of the locking notch and may in particular contact the removal chamfer. If the secret code is set at the code rings, on a pulling at the bolt along the introduction direction, the force exerted on the bolt may then be deflected by a cooperation of the removal chamfer with the second chamfer and the latch may be urged back into the unlocking position to enable a removal of the bolt from the lock body.

Furthermore, the locking notch may be bounded by the removal chamfer, on the one hand, and the aforementioned reception chamfer, on the other hand, and may therefore be shaped such that the engagement section of the latch, with the first chamfer and the second chamfer, may engage into the locking notch essentially without play in the locking position to limit and/or prevent any deflections of the bolt relative to the latch. In particular in the case of a strand lock used as a bicycle lock or in another way as a mobile lock, any noise formation during a transport of the strand lock due to such relative movements between the bolt and the latch may hereby be prevented.

In some embodiments, the first closure part may have a bearing sleeve which extends along the lock axis towards the second closure part and on which the code rings are supported.

For example, the first closure part and the bearing sleeve may be integrally formed in one piece. In this connection, an integrally single-piece closure part is to be understood as a part that is originally formed as a single materially bonded part and that may be manufactured by casting or injection molding, for example. Thus, an integrally single-piece closure part in particular differs from closure parts that are originally joined together from two or more parts and whose individual components are connected to form a releasable or permanent join connection, such as by welding or screwing.

Provision can, however, generally also be made that the first closure part and the bearing sleeve are initially manufactured as two separate parts, but are then fastened to one another by a join connection, for example by welding, pressing or screwing. In any case, provision is, however, also made in such embodiments that the first closure part already has the bearing sleeve, i.e. the bearing sleeve is connected to further sections of the first closure part when the code rings are plugged onto the bearing sleeve during the assembly of the strand lock.

Since the first closure part has the bearing sleeve, the bearing sleeve is thus provided at that closure part which also has the bolt introduction opening. Since the code rings are supported on the bearing sleeve in the assembled state of the strand lock, the code rings have to be plugged onto the bearing sleeve during the assembly, whereupon the first closure part must be connected to the second closure part in order, as a result, to form a closed lock body. In the assembled state, the code rings may consequently be arranged between a section of the first closure part having the bolt introduction opening and the second closure part, wherein the section of the first closure part and the second closure part may in particular extend radially with respect to the lock axis such that the code rings supported on the bearing sleeve are axially fixed with respect to the lock axis.

Since the first closure part has the bearing sleeve in the embodiments in question, the aforementioned connection of the first closure part to the second closure part may take place at an end of the first closure part facing away from the bolt introduction opening with respect to the lock axis. In a reverse arrangement of the bearing sleeve at the second closure part, the bearing sleeve would, however, bridge the distance from the first closure part with the bolt introduction opening so that the connection of the two closure parts would have to take place in the environment of the bolt introduction opening. In the direction of the bolt introduction opening, however, the latch must extend axially beyond the bearing sleeve with respect to the lock axis to be able to engage into the bolt introduction opening and the locking notch. A fastening of the two locking parts with such an arrangement of the bearing sleeve (at the second closure part and thus in contrast to the embodiments described here) by a fastening device engaging through the first closure part and the bearing sleeve therefore necessarily requires that the fastening device also engages through the latch so that a corresponding recess must be formed at the latch. However, such a recess is accompanied by an undesirable material weakening of the latch, whereby the resistance of the strand lock against break-open attempts may be impaired. Conversely, a limitation of this material weakening by a recess that is formed as small as possible at the latch also results in the size, and in particular the diameter, of a fastening device to be used for fastening the two closure parts to one another being limited so that the stability of the fastening of the two closure parts to one another and, in turn, the security of the strand lock against break-open attempts are restricted.

Due to the arrangement of the bearing sleeve at the first closure part, the fastening of the two closure parts may, in contrast, take place remotely from the bolt introduction opening and therefore in particular behind the latch with respect to the lock axis, viewed from the bolt introduction opening, so that any fastening device for fastening the closure parts to one another in particular does not engage into a movement path of the latch and therefore does not have to be guided through the latch either. Therefore, a recess for the guiding through of a fastening device for the closure parts does not have to be formed at the latch; rather, only the bearing sleeve and the second closure part may have suitable structures, in particular openings for a guiding through of a fastening device, to enable the connection of two closure parts. Since the connection of the two closure parts is thus not accompanied by a weakening of the latch or restricted by the dimension of the latch, the openings mentioned may, for example, be made larger compared to a reverse arrangement of the bearing sleeve to be able to use an equally larger and more stable fastening device, for example a fastening pin, for fastening the two closure parts to one another. Overall, the aforementioned arrangement of the bearing sleeve at the first closure part or the formation of the first closure part with the bearing sleeve therefore, compared to a reverse arrangement, enables a more stable connection of the two closure parts to one another and a more stable formation of the latch.

In some embodiments, the latch may be axially guided within the bearing sleeve with respect to the lock axis. In such embodiments, the bearing sleeve may in particular surround the latch at least to the greatest possible extent (in particular apart from a slot for an projection through by blocking protrusions formed at the latch, as explained in more detail below) to prevent a deflection of the latch relative to the lock axis and to guide the latch along the lock axis. The latch may in particular be axially insertable into the bearing sleeve in the course of the assembly of the strand lock.

In some embodiments, the bearing sleeve may, at an end section facing away from the bolt introduction opening, have two bearing sleeve fastening openings oriented in alignment with one another perpendicular to the lock axis and the second closure part may have at least one closure part fastening opening. The first closure part may further be connected to the second closure part by a fastening pin guided through the closure part fastening opening and the two bearing sleeve fastening openings.

In such embodiments, the fastening of the two closure parts to one another may thus take place as far away as possible from the bolt introduction opening by first guiding the fastening pin through the closure part fastening opening and then through the two bearing sleeve fastening openings formed at the end section of the bearing sleeve. Therefore, the fastening pin may in particular be positioned remote from the latch so that the movement of the latch between the locking position and the unlocking position, on the one hand, and the fastening of the two closure parts, on the other hand, may be implemented spatially separately from one another without the fastening pin also having to be guided through a movement path of the latch and in particular through the latch. As explained, this makes it possible to use a stably designed fastening pin with a corresponding extent for fastening the closure parts to one another without having to accept a material weakening of the latch.

In some embodiments, the bearing sleeve fastening openings may therefore be arranged behind the latch, starting from the bolt introduction opening viewed along the lock axis.

In some embodiments, the second closure part may have two closure part fastening openings which are oriented in alignment with one another and into which the fastening pin may engage. Alternatively thereto, the second closure part may have one closure part fastening opening and a receiver for the fastening pin, which receiver faces into an inner space of the second closure part, may be opposite the one closure part fastening opening in order to support the fastening pin at an end opposite the closure part fastening opening.

In some embodiments, the bearing sleeve may have two fastening sections which project towards the second closure part and at which the bearing sleeve fastening openings are formed.

In such embodiments, for example, a substantially tubular bearing sleeve may have two fastening sections that project towards the second closure part and that serve to fasten the two closure parts to one another. In such embodiments, the latch may in particular be supported in a tube section of the bearing sleeve, said tube section facing the bolt introduction opening with respect to the lock axis relative to the fastening sections, and/or may be surrounded by such a tube section so that the fastening sections may extend beyond the latch inserted into the bearing sleeve towards the second closure part to enable a fastening of the closure parts to one another behind the latch. A distance between the fastening openings and the latch may furthermore in particular be used for attaching a compression spring for preloading the latch into the locking position.

In some embodiments, the latch may have a guide slot extending along the lock axis and the bearing sleeve may have a latch guide opening, wherein a movement of the latch relative to the bearing sleeve may be limited by a guide pin engaging through the latch guide opening into the guide slot.

Due to the engagement of the guide pin into the guide slot, the latch may in particular be prevented from being urged beyond the locking position due to the preload since, in such a position of the latch urged beyond the locking position, the explained cooperation between the bolt and the latch could possibly be disturbed on the introduction of the bolt into the lock body. Due to the formation of the bearing sleeve at the first closure part, the guide pin, however, only serves to guide the latch and does not also have to be used to connect the two closure parts to one another so that the guide pin has no security relevance with respect to the securing of the lock against break-open attempts. The guide pin and the guide slot may therefore be small or narrow to achieve the required guidance of the latch without, however, having to accept a large material removal at the latch and a corresponding weakening of the latch.

In some embodiments, the code rings may be rotationally fixedly connected to respective coupling rings, wherein the coupling rings may have a respective blocking surface having a release recess. The latch may have blocking protrusions associated with the respective coupling rings, wherein the release recesses of all the coupling rings may be oriented in alignment with the associated blocking protrusions when the secret code is set so that the latch may be moveable against the preload relative to the coupling rings into the unlocking position. When the secret code is not set, the release recess of at least one coupling ring may, in contrast, not be oriented in alignment with the associated blocking protrusion so that the latch may be blocked against a movement against the preload into the unlocking position by the associated blocking protrusion abutting the blocking surface of the at least one coupling ring. Furthermore, in such embodiments, the coupling rings may be supported radially inwardly, with respect to the lock axis, directly on the bearing sleeve and the code rings may be radially outwardly plugged onto the coupling rings.

However, to enable a rotation of the code rings and of the coupling rings coupled thereto to set or adjust the secret code, the blocking surfaces of the coupling rings may be arranged axially offset from the blocking protrusions with respect to the lock axis when the latch is positioned in the locking position. The preload of the latch into the locking position may thus also ensure that the code rings are always rotatable when the bolt is located in the lock body and a locking or a release is to take place.

In some embodiments, the bearing sleeve may have a slot which extends along the lock axis and through which the blocking protrusions of the latch project. In particular, the bearing sleeve may have a tubular section in which the latch is axially guided, wherein the aforementioned slot may, however, be formed at the tubular section so that the blocking protrusions of the latch may extend out of the bearing sleeve and may cooperate with the coupling rings supported on the bearing sleeve.

In some embodiments, the coupling rings and the code rings may be in rotationally fixed engagement with one another by way of cooperating coupling protrusions and coupling recesses, wherein the coupling rings may be preloaded along the lock axis, in particular against the preload of the latch, into the rotationally fixed engagement with the code rings. The strand lock may further have a secret code changing device that is configured to urge the coupling rings against their preload out of engagement with the code rings into a secret code changing position in which the code rings may be rotated relative to the coupling rings in order to change the secret code.

The coupling rings may in particular be axially movable against the preload relative to the code rings with respect to the lock axis by the secret code changing device. The coupling rings may furthermore have sleeve-shaped bearing sections at which no coupling protrusions and/or coupling recesses are formed in order to support the code rings in the secret code changing position. In particular, the coupling rings may have the coupling protrusions and the code rings may have the coupling recesses.

Since the code rings are rotatable relative to the coupling rings in the secret code changing position, a changed secret code may be set after a turning of the code rings relative to the coupling rings and after a return of the coupling rings, due to the preload, to the rotationally fixed coupling with the code rings.

Furthermore, in some embodiments, it may be provided that the coupling rings may only be transferred into the secret code changing position when the secret code is set and are otherwise blocked by the latch against a movement into the secret code changing position. For example, the release recesses of the coupling rings may be axially guidable across the blocking protrusions of the latch during a movement into the secret code changing position so that, when the secret code is not set, an abutment of a blocking surface of at least one coupling ring against a blocking protrusion may prevent a transfer of the coupling rings into the secret code changing position.

In some embodiments, the blocking surfaces of the coupling rings may further have a respective rotation blocking recess and the bearing sleeve may have respective rotation blocking protrusions associated with the coupling rings, wherein the rotation blocking protrusions may engage into the rotation blocking recesses in the secret code changing position and may secure the coupling rings against a rotation about the lock axis. In particular, it may be prevented by such an engagement that the release recesses of the coupling rings may rotate relative to the blocking protrusions of the latch when the coupling rings are positioned in the secret code changing position so that a subsequent return of the coupling rings to the rotationally fixed coupling with the code rings may be ensured and the changed secret code is actually set after this return.

Furthermore, in such embodiments, the rotation blocking recesses may in particular be narrower than the release recesses and/or the blocking protrusions of the latch may in particular not be axially guidable through the rotation blocking recesses. In this regard, in such embodiments, the secret code is also to be set at the code rings and the release recesses of the coupling rings must be oriented in alignment with the blocking protrusions of the latch to be able to bring the latch into the unlocking position, whereas it is not sufficient that one of the rotation blocking recesses of the coupling rings is oriented in alignment with the blocking protrusions of the latch to be able to axially move the latch relative to the coupling rings.

In general, the secret code changing device may, in particular at the outside of the lock body, be actuable manually and/or using a corresponding tool, such as a screwdriver. Furthermore, the secret code changing device may be rotatable, for example.

In some embodiments, the secret code changing device may have an eccentric cam that may be rotated about an axis of rotation by actuating the secret code changing device, wherein the coupling rings may be movable into the secret code changing position by rotating the eccentric cam. By rotating such an eccentric cam, the coupling rings may therefore be able to be axially urged back against the aforementioned preload, in particular along the lock axis, to be able to release the rotationally fixed coupling with the code rings. The actuation of the secret code changing device for transferring the coupling rings into the secret code changing position may therefore in particular comprise a rotation of the eccentric cam by approximately or by exactly 90° to be able to utilize the full eccentricity of the eccentric cam if possible.

The axis of rotation of the eccentric cam may be oriented perpendicular to the lock axis in some embodiments. Furthermore, in some embodiments, the axis of rotation may be aligned in parallel with the introduction direction.

In some embodiments, the eccentric cam may engage at a connection element that axially contacts a coupling ring with respect to the lock axis, said coupling ring facing the second closure part.

In particular, such a connection element may make it possible to bridge a distance between the latch, which cooperates with the code rings, and the eccentric cam. For example, the connection element may further likewise be supported on the bearing sleeve mentioned, wherein the connection element may furthermore in particular surround a spring preloading the latch into the locking position. In embodiments in which, in addition to the code rings, a connection element is also supported on the bearing sleeve in a manner axially adjoining the code rings, the bearing sleeve may therefore extend axially towards the second closure part beyond a coupling ring facing away from the bolt introduction opening and beyond the latch to be able to fasten the two closure parts to one another at a spacing from the latch.

In some embodiments, the secret code changing device may have a first eccentric cam and a second eccentric cam that may be rotatable by actuating the secret changing device, wherein the first eccentric cam and the second eccentric cam may cooperate with the coupling rings at mutually offset points of engagement.

The first eccentric cam and the second eccentric cam may in particular be arranged opposite one another with respect to the mentioned axis of rotation of the at least one eccentric cam about which both the first eccentric cam and the second eccentric cam may be rotatable. The two eccentric cams may hereby cooperate with the coupling rings at points of engagement, which are offset from one another along the axis of rotation, and may in particular engage at the aforementioned connection element. A configuration with two eccentric cams may in particular make it possible to achieve a stable guidance of the coupling rings and to avoid any tilting moments relative to the lock axis on an actuation of the secret code changing device in that, due to the exertion of forces at at least two points of engagement, a uniform force distribution may be transmitted against the preload to the coupling rings.

In some embodiments, the secret code changing device may be arranged at the second closure part. In particular, the second closure part may, at an outer side, have an access opening through which the secret code changing device may be accessible for an actuation from the outside.

The secret code changing device may thus also be arranged opposite the bolt introduction opening so that the locking of the bolt, on the one hand, and the transfer of the coupling rings into the secret code changing position, on the other hand, may again be implemented spatially separately from one another without also having to provide a possibility for adjusting the secret code, for instance, at the latch.

In some embodiments, the secret code changing device may engage through an inner space of the second closure part perpendicular to the lock axis and the latch may be preloaded by a spring into the locking position, wherein the spring may be supported at the secret code changing device. Therefore, in such embodiments, the secret code changing device may likewise be arranged behind the latch, starting from the bolt introduction opening viewed along the lock axis in the direction of second closure part, so that the movement path of the latch may be kept free of other components of the strand lock.

In some embodiments, the bearing sleeve may have fastening sections which project towards the second closure part and at which two bearing sleeve fastening openings oriented in alignment with one another perpendicular to the lock axis are formed for fastening the bearing sleeve to the second closure part, wherein the secret code changing device may be arranged between the fastening sections. Furthermore, the secret code changing device may in particular engage over the fastening sections.

For example, it may be provided that the secret code changing device engages over the two projecting fastening sections of the bearing sleeve with the eccentric cams mentioned so that the secret code changing device may be held at and fixed to the bearing sleeve through the engagement over the fastening sections and the arrangement between the fastening sections.

In some embodiments, the first closure part may be fastened to the second closure part by a fastening pin guided through the bearing sleeve fastening openings, wherein the fastening pin may be arranged behind the secret code changing device, starting from the bolt introduction opening viewed along the lock axis. The fastening pin may in particular engage behind the secret code changing device and/or the secret code changing device may in particular be axially supported, with respect to the lock axis, at an end facing away from the bolt introduction opening by the fastening pin.

The bearing sleeve fastening openings and the fastening pin may in particular be the components already mentioned above for fastening the two closure parts to one another.

Since the fastening pin may be axially arranged behind the secret code changing device, viewed starting from the first closure part, the fastening pin may thus so-to-say close the bearing sleeve at an end facing away from the bolt introduction opening in order to axially fix the components arranged within the bearing sleeve. In particular, the latch, a spring for preloading the latch and the secret code changing device may therefore be fixed in the bearing sleeve by the fastening pin.

In some embodiments, the second closure part may, at an axial coupling end with respect to the lock axis, have a coupling opening into which the second strand end is introduced, wherein the second strand end may have an eyelet. The second closure part may furthermore have a strand fastening opening and the second strand end may be fastened to the second closure part by a strand fastening pin guided through the strand fastening opening and the eyelet. In particular, the strand fastening pin may in this respect be introducible perpendicular to the lock axis into the strand fastening opening.

Furthermore, in some embodiments, the strand fastening opening may, viewed from the first closure part, be arranged behind the aforementioned closure part fastening opening along the lock axis. Alternatively or additionally, the aforementioned fastening pin and the strand fastening pin may be oriented perpendicular to one another in embodiments that have both the fastening pin and the strand fastening pin.

In some embodiments, the strand hoop may be configured as a chain hoop comprising a plurality of chain links or as a rope hoop, in particular as a wire rope hoop.

### BRIEF DESCRIPTION OF THE DRAWINGS

The present disclosure will be explained in the following purely by way of example with reference to an embodiment example and to the drawings.

In the drawings:

FIG. 1 is a perspective view of a strand lock having a strand hoop, wherein a first strand end, which may be selectively released from a lock body of the strand lock or locked to the lock body by a combination locking mechanism, and a second strand end, which is permanently fastened to the lock body, of the strand hoop are shown, whereas hoop sections arranged therebetween are not shown;

FIG. 2 is an exploded representation with components of the strand lock;

FIG. 3A is an exploded representation with a selection of components of the strand lock;

FIG. 3B is an exploded representation with a selection of components of the strand lock

FIG. 4 is a perspective view of a first closure part of the lock body having a bolt introduction opening, into which a bolt formed at the first strand end may be introduced, and having a bearing sleeve for supporting code rings of the combination locking mechanism;

FIG. 5 is a perspective view of the bolt and the latch for illustrating the cooperation of the bolt and the latch for urging back the latch from a locking position into an unlocking position;

FIG. 6A is a representation of the combination locking mechanism of the strand lock for illustrating the transfer of coupling rings of the combination locking mechanism into a secret code changing position in which a secret code to be set at the code rings of the combination locking mechanism may be changed;

FIG. 6B is a representation of the combination locking mechanism of the strand lock for illustrating the transfer of coupling rings of the combination locking mechanism into a secret code changing position in which a secret code to be set at the code rings of the combination locking mechanism may be changed; and

FIG. 7 is a view of a coupling ring and a code ring couplable thereto for illustrating their cooperation.

### DETAILED DESCRIPTION

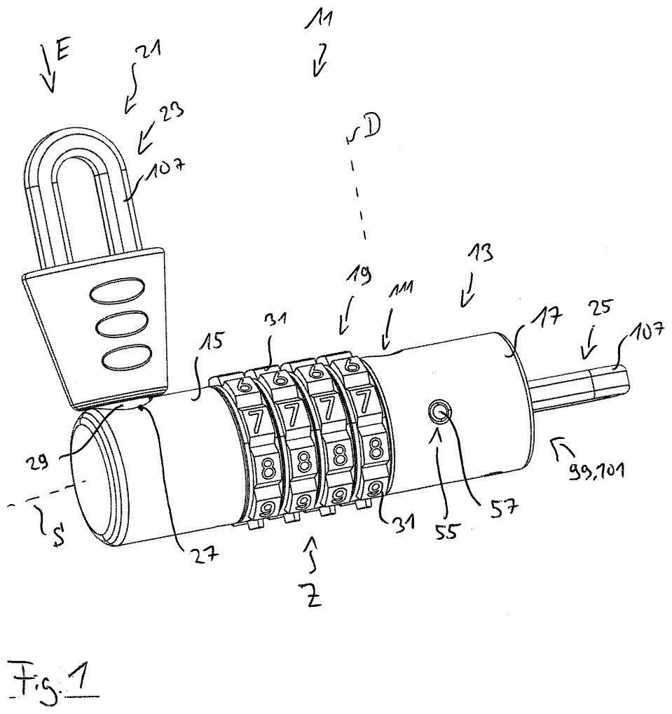

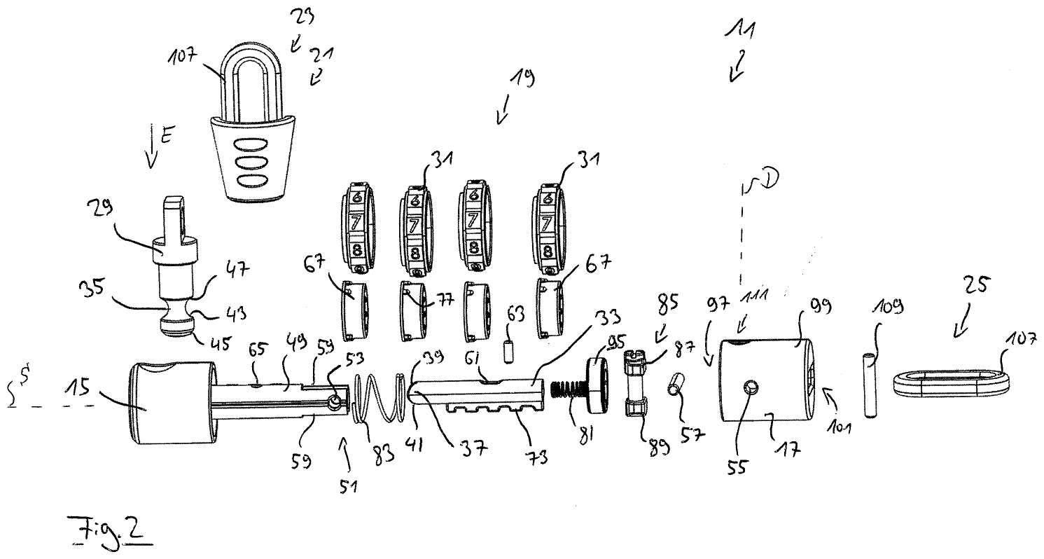

FIG. 1 shows a strand lock 11 comprising a lock body 13 and a strand hoop 21 that is configured by way of example as a chain hoop comprising a plurality of chain links 107. However, in FIG. 1, only a respective end-side chain link 107 is shown at a first strand end 23 and a second strand end 25 of the strand hoop 21, whereas chain links disposed therebetween are not shown. The chain link forming the second strand end 25 is in this respect permanently fastened to a second closure part 17 of the lock body 13, whereas, as explained in more detail below, at the first strand end 23, a bolt 29 is formed that may be selectively introduced along an introduction direction E into a bolt introduction opening 29 of a first closure part 15 of the lock body 13, and locked to the lock body 13, or released for a detachment from the lock body 13 and a removal from the bolt introduction opening 29 (cf. also FIGS. 2, 4 and 5).

A plurality of code rings 31 of a combination locking mechanism 19, at which a numerical code Z may be set, that are rotatable about a lock axis S are arranged between the first closure part 15 and the second closure part 17. As is likewise explained in more detail below, by setting a numerical code Z that corresponds to a predetermined secret code, the bolt 29 introduced into the lock body 13 may be released for a detachment from the lock body 13 against the introduction direction E oriented perpendicular to the lock axis S, whereas, by setting a numerical code Z that does not correspond to the secret code, the bolt 29 introduced into the lock body 13 may be locked to the lock body 13.

Furthermore, FIG. 1 already shows that a closure part fastening opening 55, into which a fastening pin 57 is introduced, is formed at the second closure part 17 As will be explained in more detail below, this fastening pin 57 serves to reliably connect the first closure part 15 and the second closure part 17 to one another. Furthermore, at the second closure part 17, an access opening 111 is formed through which a secret code changing device 85, likewise explained in more detail below, is accessible for an actuation.

The mode of operation and the design of the strand lock 11 can in particular be seen in the exploded representation of FIG. 2.

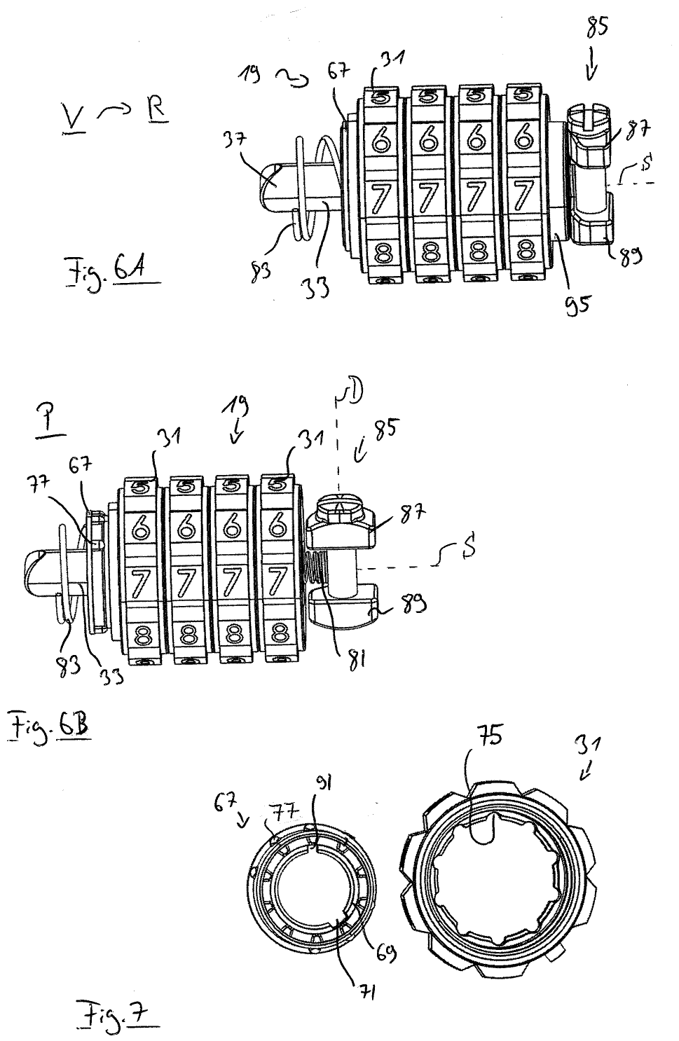

As FIG. 2 in particular shows, the first closure part 15 has a bearing sleeve 49 which extends along the lock axis S towards the second closure part 17 and on which the code rings 31 are rotatably supported about the lock axis S. Furthermore, the bearing sleeve 49 serves to axially guide a latch 33 of the combination locking mechanism 19, which latch is preloaded towards a locking position V, with respect to the lock axis S (cf. FIG. 6A). The latch 33 is preloaded into the locking position V by way of a spring 81 supported at the aforementioned secret code changing device 87 (cf. also FIG. 6B).

A peripheral locking notch 35 is formed at the bolt 29 that may be selectively introduced into the bolt introduction opening 27 and that forms the first strand end 23 of the strand hoop 21, wherein the latch 33 is configured, in the locking position V, to engage into the locking notch 35 with an engagement section 37. If the latch 33 is blocked in the locking position V, the bolt 29 introduced into the lock body 13 may therefore also be blocked by the latch 33 against a removal from the bolt introduction opening 27.

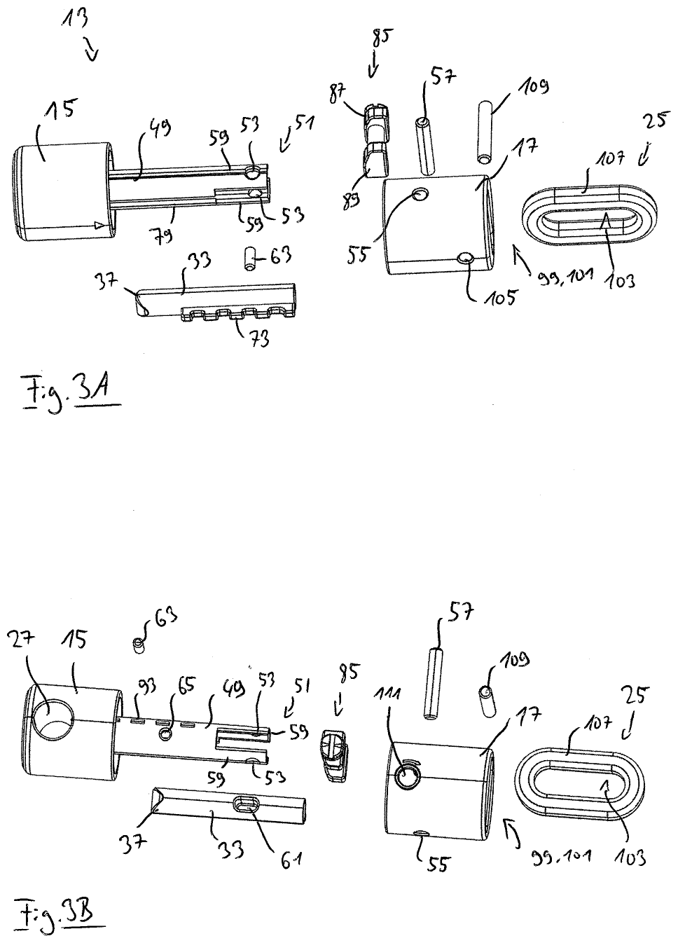

As already mentioned, the latch 33 may be blockable in the locking position V in that a numerical code Z is set at the code rings 31 that differs from a predetermined secret code. As can be seen from FIG. 2, the code rings 31 are coupled to respective coupling rings 67 that are directly supported by the bearing sleeve 49. The latch 33 furthermore has respective blocking protrusions 73 that are associated with the coupling rings 67 and that project through a slot 79 formed at the bearing sleeve 79 to be able to cooperate with the coupling rings 67 (cf. also FIG. 3A).

FIG. 7 shows that the coupling rings 67 have respective coupling protrusions 77 that engage into respective coupling recesses 75 formed at the associated code rings 31 to be able to rotationally fixedly couple the code rings 31 to the coupling rings 67. Furthermore, at the coupling rings 67, a peripheral blocking surface 69 that is radially inwardly disposed with respect to the lock axis S is provided that, however, has a release recess 71 and a rotation blocking recess 91. By setting the secret code at the code rings 31, all the release recesses 71 may be oriented in alignment with the respective associated blocking protrusion 73 of the latch 33 so that the latch 33 may be urged along the lock axis S relative to the coupling rings 67 and against the preload developed by the spring 81 into an unlocking position R in which the latch 33 does not engage into the locking notch 35 of the bolt 29 introduced into the lock body 13 (cf. also FIG. 6A).

However, if the secret code is not set at the code rings 31, at least the release recess 71 of one of the coupling rings 67 is not oriented in alignment with the associated blocking protrusion 73 of the latch 33 so that the latch 33 abuts the blocking surface 69 of the coupling ring 67 on a movement against the preload and is thereby blocked against such a movement. Furthermore, the rotation blocking recesses 91 are narrower than the release recesses 71 so that even the rotation of a rotation blocking recess 91 in alignment with a blocking protrusion 73 does not result in the latch 33 being movable against the preload out of the locking position V since the blocking protrusion 73 cannot be guided through the rotation blocking recess 91.

If the secret code is thus set at the code rings 31, the latch 33 may generally be urged out of the locking position V along the lock axis S against the preload developed by the spring 81. In order not to have to provide an additional actuation element for the latch 33 in this respect, but, when the secret code is set, to be able to introduce the bolt 29 directly into the lock body 13 or remove it from the lock body 13, a first chamfer 39 and a second chamfer 41 are formed at the engagement section 37 of the latch 33 and the bolt 29 has an introduction chamfer 45 and a removal chamfer 43. Due to the cooperation of the chamfers 39, 41, 43 and 45, it may be achieved that, when the secret code is set, the latch 33 may be urged against the preload back into the unlocking position E by introducing the bolt 29 into the bolt introduction opening 27 or by removing the bolt 29 from the bolt introduction opening 27 in order to release a movement path of the bolt 29.

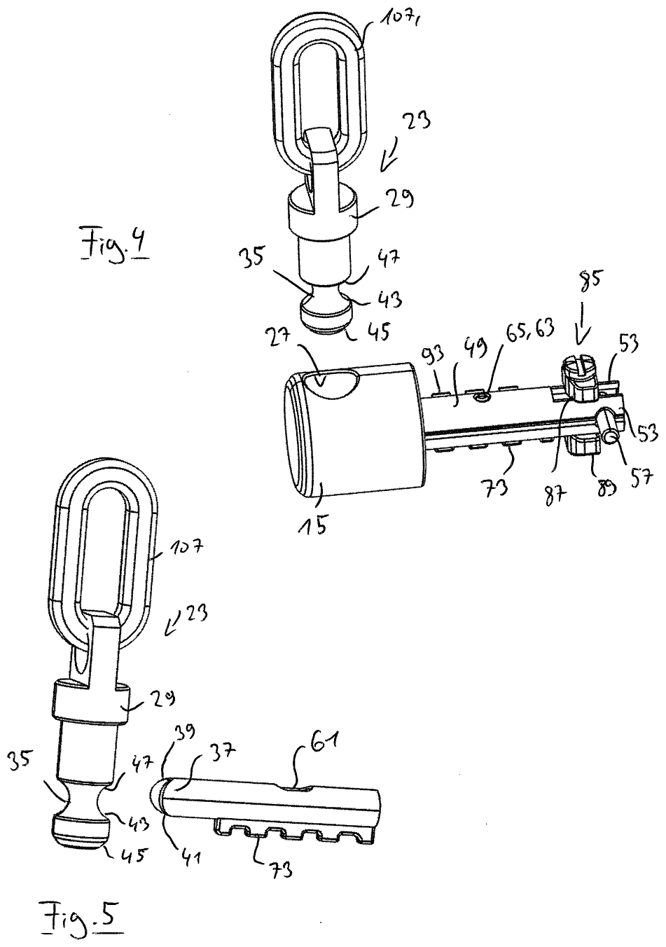

On an introduction of the bolt 29 into the bolt introduction opening 27, the latch 33 located in the locking position V may in particular be urged back by the cooperation of the introduction chamfer 45 of the bolt 29 with the first chamfer 39 of the latch 33 in that a force developed by the bolt 29 along the introduction direction E is deflected by this cooperation. When the bolt 29 is introduced, the engagement section 37 of the latch 33 engages into the locking notch 35 bounded by the removal chamfer 43 and a reception chamfer 47 opposite the removal chamfer 43; however, said engagement section 37 may be urged back against the preload by the cooperation of the removal chamfer 43 with the second chamfer 41 of the latch 33 on a removal of the bolt 29 from the lock body 13. In this regard, only the secret code has to be set at the code rings 31, whereupon the bolt 29 and thus the first strand end 23 may be introduced directly into the bolt introduction opening 27 or removed from the bolt introduction opening 27 (cf. also FIG. 5 with respect to the chamfers provided at the bolt and the latch).

The chamfers 39, 41, 43, 45 and 47 are in particular curved in the illustrated embodiment, wherein, alternatively, a planar design of the chamfers 39, 41, 43, 45 and 47 could, however, also be provided, for example.

To be able to securely connect the first closure part 15 to the second closure part 17, two bearing sleeve fastening openings 53 oriented in alignment with one another perpendicular to the lock axis S are provided at fastening sections 59 of the bearing sleeve 49 of the first closure part 15 that extend away from the bolt introduction opening 27 so that the bearing sleeve fastening openings 53 are in particular arranged at an end section 51 of the bearing sleeve 49 facing away from the bolt introduction opening 27. At the second closure part 17, the aforementioned closure part fastening opening 55 oriented perpendicular to the lock axis S is furthermore provided so that the first closure part 15 and the second closure part 17 may be fastened to one another by guiding the fastening pin 57 through the closure part fastening opening 55 and the bearing sleeve fastening openings 53. For example, in an inner space 97 of the second closure part 17, a receiver, not shown, for the fastening pin 57 may be provided opposite the closure part fastening opening 55 to be able to stably support the fastening pin 57.

Since the bearing sleeve 49 is part of the first closure part 15—and not, for instance, of the second closure part 17—and since the bearing sleeve fastening openings 53 are formed at the end section 51 of the bearing sleeve 49 facing away from the bolt introduction opening 27, the fastening of the two closure parts 15 and 17 to one another may take place spaced apart from the bolt introduction opening 27. Furthermore, as can particular be seen from FIGS. 4 and 6B, the fastening of the closure parts 15 and 17 to one another in particular takes place such that the fastening pin 57 is arranged outside a movement path of the latch 33 and does not have to be guided through the latch 33. Rather, the fastening pin 57 is arranged behind the latch 33, starting from the bolt introduction opening 27 viewed along the lock axis S. This may make it possible to configure the fastening pin 57 in a stable manner and with a comparatively large diameter since the fastening pin 57 thus does not have to be guided through the latch 33 and no recess has to be provided at the latch 33 for the guiding through of the fastening pin 57, as would be the case with an arrangement of the bearing sleeve 49 at the second closure part 17.

Furthermore, a latch guide opening 65 is, however, provided at the bearing sleeve 49 and the latch 33 has a guide slot 61, wherein a guide pin 63 is guided through the latch guide opening 65 into the guide slot 61 in order to limit an axial movement of the latch 33 with respect to the lock axis S. In particular, due to this engagement of the guide pin 63, the latch 33 may be prevented from moving beyond the locking position V so that the cooperation of the first chamfer 39 with the introduction chamfer 45 of the bolt 29 may be ensured when the bolt 29 is removed. However, since the guide pin 63 does not have to connect the two closure parts 15 and 17 to one another and therefore has no security relevance with respect to the securing the strand lock 11 against break-open attempts, the guide pin 63 may be compact and narrow so that the formation of the equally narrow guide slot 61 at the latch 33 is only accompanied by a slight material removal at the latch 33 without impairing the stability of the latch 33.

FIGS. 2, 3A and 3B further show that the second closure part 17 has, at a coupling end 99 opposite the bolt introduction opening 27, a coupling opening 101 into which the chain link 107 forming the second strand end 25 may be introduced. Furthermore, a strand fastening pin 109 is provided that may be guided through a strand fastening opening 105 formed at the second closure part 107 to engage into an eyelet 103, which is formed by the chain link 107 and thus by the second strand end 25, and to thereby permanently fasten the chain link 107 to the second closure part 17. The strand fastening pin 109 is oriented perpendicular to the lock axis S and the fastening pin 57 and is further arranged behind the fastening pin 57, starting from the bolt introduction opening 27 viewed along the lock axis S.

To further be able to selectively change the secret code, a secret code changing device 85 accessible from the outside at the lock body 13 is provided. As can in particular be seen from FIGS. 6A and 6B, the secret code changing device 85 has two eccentric cams 87 and 89 rotatable about an axis of rotation D oriented perpendicular to the lock axis S. The eccentric cams 87 and 89 engage at respective points of engagement, which are offset along the axis of rotation D, at a connection element 95 that, in turn, contacts a coupling ring 67 facing the secret code changing device 85. As FIG. 6B shows, by actuating the secret code changing device 85 and rotating the eccentric cams 87 and 89, the connection element 95 and, via it, the coupling rings 67, which are preloaded by a spring 83 in a rotationally fixed coupling with the code rings 31, may be transferred into a secret code changing position P. In this secret code changing position P, the coupling rings 67 are moved axially relative to the associated code rings 31 and the coupling elevations 67 move out of engagement with the coupling recesses 75 so that the code rings 31 may be rotated relative to the coupling rings 35 and the secret code may be changed. Furthermore, respective rotation blocking protrusions 93 associated with the coupling rings 67 are formed at the bearing sleeve 49, wherein the already mentioned rotation blocking recesses 91 formed at the coupling rings 67 enter into engagement with the rotation blocking protrusions 93 in the secret code changing position P to prevent a rotation of the coupling rings 67 (cf. in particular FIG. 3B).

FIG. 6B further shows that the spring 81 for preloading the latch 33 is supported at the secret code changing device 85 that engages through the inner space 97 of the second closure part 17. Furthermore, in particular FIG. 4 shows that the secret code changing device 85 is arranged in front of the fastening pin 57, viewed from the bolt introduction opening 27 along the lock axis S, and is engaged behind by the fastening pin 57 along the lock axis S. Moreover, the eccentric cams 87 and 89 engage over the fastening sections 53 of the bearing sleeve 49 so that the secret code changing device 85 is completely held at the bearing sleeve 49.

### REFERENCE NUMERAL LIST

11 strand lock
13 lock body
15 first closure part
17 second closure part
19 combination locking mechanism
21 strand hoop
23 first strand end
25 second strand end
27 bolt introduction opening
29 bolt
31 code ring
33 latch
35 locking notch
37 engagement section
39 first chamfer
41 second chamfer
43 removal chamfer
45 introduction chamfer
47 reception chamfer
49 bearing sleeve
51 end section of the bearing sleeve
53 bearing sleeve fastening opening
55 closure part fastening opening
57 fastening pin
59 fastening section
61 guide slot
63 guide pin
65 latch guide opening
67 coupling ring
69 blocking surface
71 release recess
73 blocking protrusion
75 coupling recess
77 coupling protrusion
79 slot
81 spring
83 spring
85 secret code changing device
87 eccentric cam
89 eccentric cam
91 rotation blocking recess
93 rotation blocking protrusion
95 connection element
97 inner space
99 coupling end
101 coupling opening
103 eyelet
105 strand fastening opening
107 chain link
109 strand fastening pin
111 access opening
D axis of rotation
E introduction direction
P secret code changing position
R unlocking position
S key axis
V locking position
Z numerical code

What is claimed is:

1. A strand lock, comprising:
a lock body that has a first closure part and a second closure part;
a combination locking mechanism oriented along a lock axis; and
a strand hoop extending from a first strand end to a second strand end, wherein the first strand end is formed by a bolt that can be selectively locked to the lock body or released from the lock body and wherein the second strand end is permanently fastened to the second closure part,
wherein the first closure part has a bolt introduction opening through which the bolt can be introduced into the lock body along an introduction direction oriented transversely to the lock axis,
wherein the combination locking mechanism has a plurality of code rings rotatable about the lock axis for setting a numerical code and a latch preloaded along the lock axis into a locking position, and
wherein the bolt has a locking notch into which the latch engages in the locking position when the bolt is introduced into the lock body,
wherein the latch is released for a movement against the preload into an unlocking position when a numerical code is set at the code rings that corresponds to a secret code,
wherein, in the unlocking position, the latch unblocks a movement path of the bolt for an introduction into the lock body or for a removal from the lock body, wherein the latch is blocked against a movement into the unlocking position if a numerical code is set at the code rings that does not correspond to the secret code, and
wherein, when the secret code is set, the latch can be urged from the locking position into the unlocking position by introducing the bolt that is released from the lock body into the lock body and by removing the bolt that is introduced into the lock body.

2. A strand lock according to claim 1,
wherein the bolt and the latch have chamfers that cooperate during at least one of the introduction or the removal, wherein the latch can be urged into the unlocking position by the cooperation of the chamfers.

3. A strand lock according to claim 1,
wherein the first closure part has a bearing sleeve which extends along the lock axis towards the second closure part and on which the code rings are supported.

4. A strand lock according to claim 3,
wherein the latch is axially guided within the bearing sleeve with respect to the lock axis.

5. A strand lock according to claim 3,
wherein the bearing sleeve has, at an end section facing away from the bolt introduction opening, two bearing sleeve fastening openings oriented in alignment with one another perpendicular to the lock axis, and wherein the second closure part has at least one closure part fastening opening, wherein the first closure part is connected to the second closure part by a fastening pin guided through the closure part fastening opening and the two bearing sleeve fastening openings.

6. A strand lock according to claim 5,
wherein the bearing sleeve fastening openings are arranged behind the latch, starting from the bolt introduction opening viewed along the lock axis.

7. A strand lock according to claim 5,
wherein the bearing sleeve has two fastening sections which project towards the second closure part and at which the bearing sleeve fastening openings are formed.

8. A strand lock according to claim 3,
wherein the latch has a guide slot extending along the lock axis and wherein the bearing sleeve has a latch guide opening, wherein a movement of the latch relative to the bearing sleeve is limited by a guide pin engaging through the latch guide opening into the guide slot.

9. A strand lock according to claim 3,
wherein the code rings are rotationally fixedly connected to respective coupling rings, wherein the coupling rings have a respective blocking surface having a release recess, wherein the latch has respective blocking protrusions associated with the coupling rings, wherein, when the secret code is set, the release recesses of all the coupling rings are oriented in alignment with the associated blocking protrusions so that the latch can be moved against the preload relative to the coupling rings into the unlocking position, and wherein, when the secret code is not set, the release recess of at least one coupling ring is not oriented in alignment with the associated blocking protrusion so that the latch is blocked against a movement against the preload into the unlocking position by the associated blocking protrusion abutting the blocking surface of the at least one coupling ring.

10. A strand lock according to claim 9,
wherein the bearing sleeve has a slot which extends along the lock axis and through which the blocking protrusions of the latch project.

11. A strand lock according to claim 9,
wherein the coupling rings and the code rings are in rotationally fixed engagement with one another by means of cooperating coupling protrusions and coupling recesses, wherein the coupling rings are preloaded along the lock axis into the rotationally fixed engagement with the code rings, wherein the strand lock has a secret code changing device that is configured to urge the coupling rings against their preload out of engagement with the code rings into a secret code changing position in which the code rings can be rotated relative to the coupling rings in order to change the secret code.

12. A strand lock according to claim 11,
wherein the blocking surfaces of the coupling rings further have a rotation blocking recess and wherein the bearing sleeve comprises respective rotation blocking protrusions associated with the coupling rings, wherein the rotation blocking protrusions engage into the rotation blocking recesses in the secret code changing position and secure the coupling rings against a rotation about the lock axis.

13. A strand lock according to claim 11,
wherein the secret code changing device has an eccentric cam that can be rotated about an axis of rotation by actuating the secret code changing device, wherein the coupling rings can be moved into the secret code changing position by rotating the eccentric cam.

14. A strand lock according to claim 11,
wherein the secret code changing device has a first eccentric cam and a second eccentric cam that can be rotated by actuating the secret changing device, wherein the first eccentric cam and the second eccentric cam cooperate with the coupling rings at mutually offset points of engagement.

15. A strand lock according to claim 11,
wherein the secret changing device is arranged at the second closure part.

16. A strand lock according to claim 15,
wherein the secret code changing device engages through an inner space of the second closure part perpendicular to the lock axis, wherein the latch is preloaded by a spring into the locking position, wherein the spring is supported at the secret code changing device.

17. A strand lock according to claim 11,
wherein the bearing sleeve has two fastening sections which project towards the second closure part and at which two bearing sleeve fastening openings are formed for fastening the bearing sleeve to the second closure part, wherein the secret code changing device is arranged between the fastening sections.

18. A strand lock according to claim 11,
wherein the first closure part is fastened to the second closure part by a fastening pin guided through the bearing sleeve fastening openings, wherein the fastening pin is arranged behind the secret code changing device, starting from the bolt introduction opening viewed along the lock axis.

19. A strand lock according to claim 1,
wherein the second closure part has, at an axial coupling end with respect to the lock axis, a coupling opening into which the second strand end is introduced, wherein the second strand end has an eyelet, wherein the second closure part has a strand fastening opening, wherein the second strand end is fastened to the second closure part by a strand fastening pin guided through the strand fastening opening and the eyelet.

20. A strand lock according to claim 1,
wherein the strand hoop is configured as a chain hoop or a rope hoop.
